(19) United States
(12) Patent Application Publication
(10) Pub. No.: US 2003/0045428 A1
(43) Pub. Date: Mar. 6, 2003

(54) Bacillus laterosporus strain CM-3 for promoting grain crop yields

(75) Inventor: Randolph S. Porubcan, Shakopee, MN (US)

Correspondence Address: Eric P. Mirabel, Esq., Winstead Sechrest & Minick P.C., 2400 Bank One Center, 910 Travis St., Houston, TX, 77002, US

(73) Assignee: Microbes, Inc., The Woodlands, TX

(21) Appl. No.: 10/101,344

(22) Filed: Mar. 19, 2002

Related U.S. Application Data
(60) Provisional application No. 60/303,215, filed on Jul. 5, 2001.

(51) Int. Cl. A01N 63/00

(52) U.S. Cl. 504/117

(57) ABSTRACT

Disclosed are processes for increasing the yields of grain crops, e.g., rice, corn, alfalfa, oats, wheat, barley, hops, and the like, through application of spores or live cells of strain CM-3 of Bacillus laterosporus (deposited at the American Type Culture Collection, P.O. Box 1549, Manassas Va. 20108, under Deposit Designation No. PTA-3593). Application of spores of strain CM-3 to rice plants at between 0.6 trillion to 50 trillion (0.6×10¹² to 5.0×10¹³) colony forming units (“cfu”)/hectare (“ha”)/crop cycle, substantially increased the yield of grain/ha, up to 7.3 metric tons/ha. The applications of strain CM-3 to rice plants can be started during the nursery period, before the plants are placed in the rice paddy.

### CROSS REFERENCE TO RELATED APPLICATIONS

This application claims priority to provisional application serial No. 60/303,215, filed on Jul. 5, 2001.

### BACKGROUND OF THE INVENTION

The use of viable microorganisms as root-zone inoculants, particularly beneficial bacteria, has expanded in the last decade to include many food crops including fruits, vegetables, root crops and grains. The emerging science, referred to as probiotics, is based in part on the observation that certain soils which contain specific cultures of microorganisms that aggressively colonize root surfaces suppress a variety of plant diseases. It is postulated that colonization of root surfaces with deleterious microorganisms can be prevented by pre-colonization with probiotic microorganisms, which is referred to as competitive exclusion, or CE. Schroth et al. discussed CE in a review article in 1982 entitled “Disease-Suppressive Soil and Root-Colonizing Bacteria”, Science, Vol. 216: 1376-1381 (1982). In this review, gram-negative Pseudomonas bacterial species were discussed as being the most effective in CE, and their ability to produce iron-binding compounds (called “siderophores”) was postulated as the potential mode-of-action.

There have, in fact, been suggestions to commercialize cultures of Pseudomonas bacteria as probiotics for food crop production. U.S. Pat. No. 5,503,651 discusses plant growth promoting rhizobacteria (referred to therein as “PGPR”), and in a listing of 41 PGPR bacterial species and strains, 37 of them are Pseudomonas species and strains. Since strains of these same Pseudomonas species and strains are plant pathogens, and since plasmid transfer within a bacterial species is commonplace, there is a concern that there could be transfer of genetic material from a pathogenic strain, to convert a previously harmless strain into a pathogenic strain. Accordingly, it is preferred to use gram-positive bacteria, such as Bacillus, and not gram-negative Pseudomonas, for probiotics.

U.S. Pat. No. 4,877,738 (Handelsman et al) discusses a seed inoculum for application to seeds to be protected from damping off fungal plant disease, and a method of protecting growing plants from damping off and root rot fungal plant disease with a similar composition. The composition includes a carrier and an effective quantity of protective bacteria, including Bacillus cereus ATCC 53522, a mutant of Bacillus cereus ATCC 53522 retaining the capability to produce a plant protecting toxin effective against Phytophthora megasperma, a mixture of such mutants, and a mixture of Bacillus cereus ATCC 53522 and such mutants wherein the inoculum is substantially soil-free. There is no mention that testing of any other Bacillus species for such purposes had the same effect.

U.S. Pat. No. 4,952,229 discusses a microbial plant supplement and method for increasing plant productivity and quality, which includes a mixture of microbes with various in vivo properties. Thirty-nine microbial species representing 15 genera are listed in this patent; however, Bacillus laterosporus, is not mentioned. This patent also states that the microbes should be used with certain organic acids, and preferably, with trace minerals.

The technology discussed in U.S. Pat. No. 4,952,229 may also present commercialization hurdles, in that it would be difficult and expensive to insure uniform end-products due to the difficulties associated with consistently combining a plurality of microorganisms. Without a consistent and uniform end-product, it would be difficult to obtain the regulatory permits required for sales and marketing of such products. It is preferable, therefore, if a single strain of a single species is the only active ingredient in a commercial product.

Takahara et al. in U.S. Pat. No. 5,441,735 discuss the use of the microorganism Erwina carotovora subsp. carotovora (E234M403 strain) which they have modified by mutagenesis to eliminate its soft rot pathology in rice. When applied to rice plants this modified strain competitively excludes pathogenic strains of the same species. The disadvantage with this strain is the same as discussed above with Pseudomonas, i.e., a reversion to pathology is possible since this microorganism is pathogenic prior to mutation. Also, it is clear that this microorganism is of no benefit to rice that is not experiencing a soft rot infection.

Carlson et al. in U.S. Pat. No. 5,157,207 discuss a method of inoculating bacteria into rice by introducing a bacterial cell into the seed or plant, such bacteria belonging to the species Calvibacter xyli. This creates a modified rice plant that demonstrates a slight yield improvement (4.81 kg/ha treated vs. 4.66 kg/ha control). Microbial invasion into rice plant tissue is not preferred, however, as it raises possible health and regulatory concerns.

There is a need for new enhancing yields in rice farming beyond those achieved with modern “high yielding” rice varieties. From 1964 to 1990, irrigated rice field yields in Asia increased from 3.0 to 5.8 metric tons/ha. This was largely the result of the introduction of the higher yielding IR varieties of rice developed by the International Rice Research Institute in the Philippines, starting with IR-8 in 1966. At the time of introduction, IR-8 yielded 10 metric tons/ha in the Philippines and up to 14 metric tons/ha in certain temperate regions of China, where fewer overcast days resulted in enhanced photosynthesis. Yields from variety IR-8, as well as other IR varieties, have decreased at a rate of 0.2 metric tons/ha/yr (Pingali, et al.). Today, yields of 6 metric tons/ha are seldom achieved by Asian farmers. New rice varieties are being selected more for disease resistance, shorter photoperiod, and grain quality than for yield. It has become generally accepted within the industry that yield increases from advances in plant genetics have been effectively maximized, and further increases can only be achieved by other means.

### SUMMARY OF THE INVENTION

The invention includes increasing the yields of grain crops, e.g., rice, corn, alfalfa, oats, wheat, barley, hops, and the like, through application of spores or live cells of Bacillus laterosporus strain CM-3 (deposited at the American Type Culture Collection (“ATCC”), P.O. Box 1549, Manassas Va. 20108, under Deposit Designation No. PTA-3593). Spores can be obtained by ultra-filtration, centrifugation, spray-drying, freeze-drying, or combinations thereof. Spores may be more marketable, as they have a longer shelf-life than live cells.

The spores of this CM-3 strain have a similarity index (based on cellular fatty acid profile analysis) of 0.691 to spores of Bacillus laterosporus, in an analysis wherein two samples with a similarity index above 0.5 are considered comparable. Application of spores of strain CM-3 to rice plants at between 0.6 trillion to 50 trillion (0.6×10¹² to 5.0×10¹³) colony forming units (“cfu”)/hectare (“ha”)/crop cycle, substantially increased the yield of grain/ha, up to 7.3 metric tons/ha.

The spores of strain CM-3 can be applied in a suspension with water, preferably chlorine-free water, which suspension may include other additives and ingredients as well. It has been found to be further advantageous to sub-divide the total colony forming units applied into 2-6 separate applications over the course of the crop growth cycle.

For application of Bacillus laterosporus to rice crops, the rice plants may be grown and the spores or cells applied thereto, by any of a number of conventional methods, including: (i) direct-seeding (broadcast seeding) of paddy rice, (ii) direct-seeding of upland rice farmed on dry land, or preferably (iii) application to transplanted paddy rice wherein the seedlings are first raised in a nursery plot, and first treated in the nursery plot, prior to being transplanted to the paddy.

The spores of the CM-3 strain have the ability to adhere to the living root tissue of rice plants, thereby facilitating use. The mechanism by which the CM-3 strain spores increases rice crop yields is not known. It is postulated that it may result from competitive exclusion of deleterious microorganisms that often colonize root tissue or by the production of auxin-like compounds that stimulate plant growth.

The making and using of the invention and the best mode known are described in further detail below.

### BRIEF DESCRIPTION OF THE DRAWINGS

FIG. 1 is a table that shows the cellular fatty acid (CFA) analysis for Bacillus laterosporus, strain CM-3; and

FIG. 2 is a scanning electron microscope (SCM) photograph of Bacillus laterosporus, strain CM-3, adhered to rice plant roots, magnified 2,200 times.

### DETAILED DESCRIPTION OF THE INVENTION

A. Preparing a Spore Suspension

Suitable microbiological media for the cultivation of Bacillus laterosporus strain CM-3 spores include Tryptic soy broth (TSB) and Schaeffer's Sporulation Medium, as discussed in Biology of Bacilli (Doi, et al. Butterworth-Heinemann, 1992). The medium of choice is prepared in baffled Erlenmeyer flasks and sterilized at 121° C. under 15 psig for 30 minutes, or until rendered sterile. It is desirable to under fill the Erlenmeyer flasks to optimize aeration during shaking; 200 ml of medium works well in a 4 liter Erlenmeyer flask. The flask is fitted with a sterile filter cap that allows the contents to breath without becoming contaminated. The sterile medium is inoculated from a slant culture on tryptic soy agar, preferably by having a slant medium with good colony growth melted and poured into the Erlenmeyer flask. The inoculated medium is then shaken on a rotary orbital shaker at 100-200 rpm and incubated at 32° C. for 48 hours. Thus prepared, the CM-3 strain will be 90% sporulated by 48 hours. If vegetative cells are required, a sample thereof can be taken from the suspension at 18-24 hours after innoculation. Typically, when using TSB as the medium, a viable spore count of about 10⁸/ml will be reached within 48 hours. The resulting spore suspension, without further preparation, can be applied to rice or other grain plants. If the spore suspension is not used within one week of preparation, it must be refrigerated at 5° C. to preserve it for later use. Spore suspensions refrigerated at 5° C. have a half-life of about two months when prepared according the above procedure.

The Bacillus laterosporus strain CM-3 spores may also be purified or concentrated using methods such as ultra-filtration, centrifugation, spray-drying or freeze-drying to generate a packaged product. Such preparations may be more marketable due to their longer shelf-life, but freshly-prepared suspensions may be even more efficacious.

The spores may be present in a composition that includes water, or water and additives and excipients that do not have a deleterious effect on the action of the spores, or water, additives and excipients and other ingredients conventionally used in spore preparations, e.g., binders, dry feeds, and the like. The composition may also include certain nutrient organic compounds and trace minerals or vitamins, or growth factors and adjuvants, although it is unknown if all of these additives act to increase crop yield. Vitamin additives may be selected, for example, from pantothenic acid, pyridoxine, riboflavin, thiamin, 25-hydroxy vitamin A, and vitamins B12, C, D, E, K, biotin, choline, folacin and niacin. Mineral additives may be selected, for example, magnesium, potassium, sodium, copper, iodine, iron, manganese calcium, phosphorous, selenium, chlorine and chromium pincolinate. The concentration of the vitamins and minerals will depend upon the plant being treated but, in general, will be between about 0.01% and about 5% by weight of the dry matter.

The Bacillus laterosporus strain CM-3 may also be combined with other bacterial species, including but not limited to Shroth's gram-negative Pseudomonas species. This Pseudomonas species has been described as being effective in producing siderophores, which compounds are believed to be the mode-of-action for a demonstrated increase in crop production by application of this Pseudomonas species. However, since there are strains of Pseudomonas species that are plant pathogens, and since plasmid transfer within a bacterial species can be commonplace, there is a concern such transfer could convert a previously harmless strain into a pathogenic strain.

B. Characterization of Strain CM-3

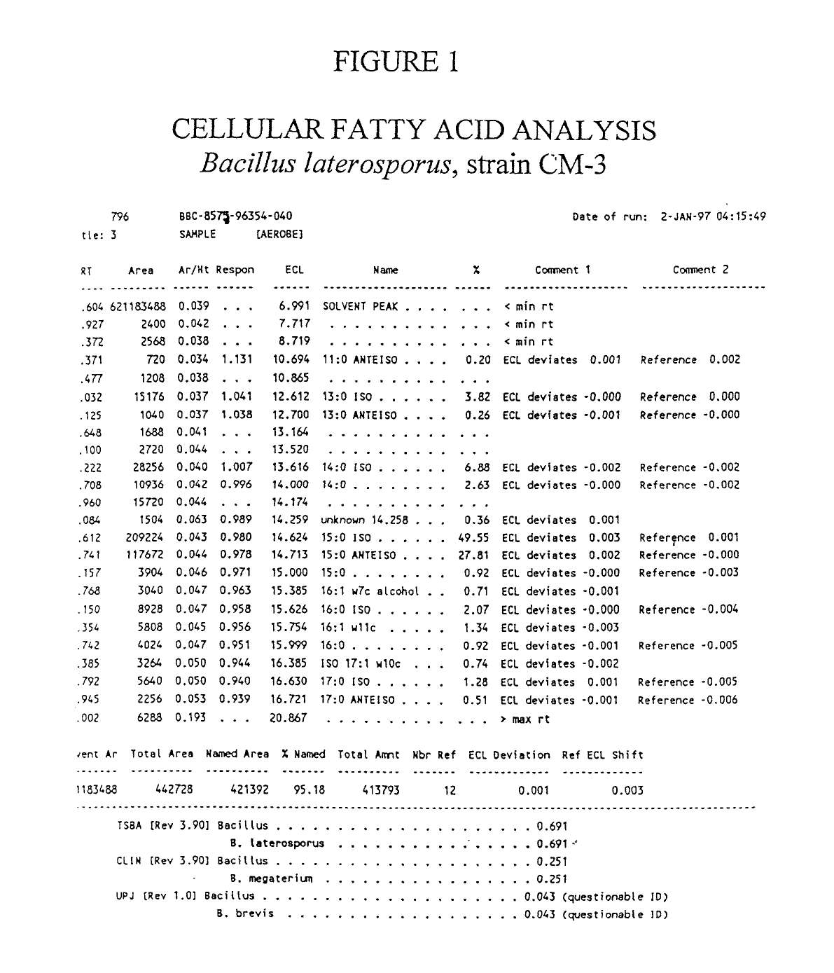

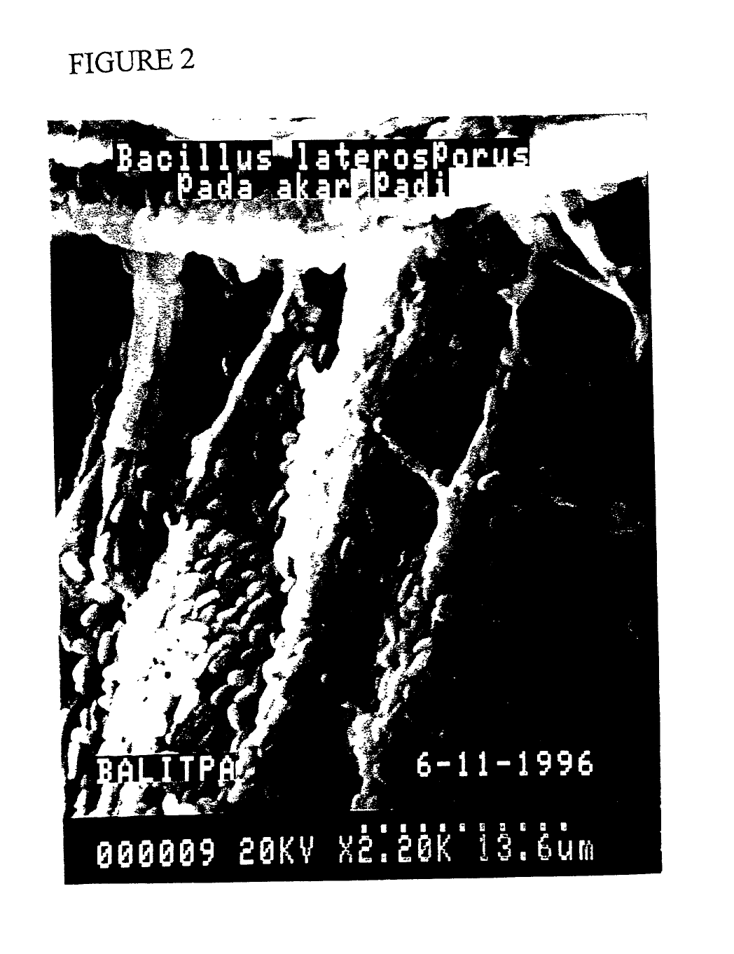

CM-3 has been characterized morphologically and physiologically and these results are summarized in Table 1 and in FIGS. 1 and 2.

TABLE 1
Characteristics of Bacillus laterosporus strain CM-3
Morphological Data:

Gram positive rod-slender and motile, length 2-6 um, width <1 um.
Sporangium-not swollen.
Endospores are oval and cradled by canoe-shaped parasporal body.
Endospores located sub-middle.
Rods may curve and become spindle-shaped when they produce
endospores.

Physiological Data: (+ = positive, n = negative)

| Parameter | Result |
|---|---|
| Anaerobic growth | + |
| Catalase | + |
| Growth at 65° C. | n |
| Starch hydrolysis | n |
| Gelatin liquification | n |
| Casein hydrolysis | + |
| Glucose (acid, no gas) | + |
| Mannitol | n |
| Glycerol | + |
| Arabinose | n |
| Xylose | n |
| Citrate utilization | n |
| Growth at < pH 5.7 | n |
| Growth in 7% NaCl | n |
| Nitrate reduction | + |
| Methyl red test | + |
| Oxidase | + |
| Trehalose (acid, no gas) | + |
| Lactose | n |
| Sucrose | n |
| Fructose | + |
| Urea hydrolysis | n |
| Esculin hydrolysis | + |
| Arginine utilization | + |
| Phenylalanine deamination | n |

FIG. 1 presents the cellular fatty acid (CFA) analysis for Bacillus laterosporus strain CM-3. The figure lists the various retention times (RT column) and areas under the peaks (area column) for the fatty acids present in an extract of the Bacillus cells. The CM-3 strain was subcultured twice and analyzed using the MIDI/Hewlett Packard Microbial Identification System (MIS). The data were obtained on high-resolution gas chromatograph and the analysis, taken in total, represents a biochemical fingerprint of the organism. The profile obtained was compared to the profile of the type strain for the indicated species by computer analysis. A similarity index is given at the bottom of the profile and it represents the percent agreement with the type strain. A Similarity Index of 0.500 or higher is considered a close comparison. In this analysis the CM-3 strain shows a Similarity Index of 0.691 or 69% to the Bacillus laterosporus type strain.

FIG. 2 presents a scanning electron microscope (SCM) photograph of Bacillus laterosporus, strain CM-3, magnified 2,200 times, adhered to rice roots. Rice roots from sterile rice plants (20 days post germination) were soaked for 15 minutes at 30° C. in an aqueous suspension containing 10 million cfu/ml of CM-3 vegetative cells obtained from a 18 hour aerobic fermentation of the CM-3 strain in tryptic soy broth. After soaking, the roots were rinsed twice with sterile distilled water to remove any non-adherent bacterial cells and were then prepared for the SCM microscopy and photography. It is apparent from the SCM photomicrograph that strain CM-3 effectively adheres to rice root tissue.

C. Applying Strain CM-3 to Crops

The spores can be applied as an aqueous suspension obtained directly from the fermentation process described above, or, if the spores are purified or concentrated using methods such as ultra-filtration, centrifugation, spray-drying or freeze-drying, they should be re-suspended in water before application to crops. When the spores are applied as an aqueous suspension taken directly from the fermentation broth, other substances present in the broth will also be applied to the crops. These non-viable substances, such as bacterial metabolites or un-utilized microbial nutrients, will be applied to the plants in very small concentrations, such as 100 grams/ha or less. This level of non-viable substance will not deleteriously affect the crop.

The Bacillus laterosporus, strain CM-3, can be applied to rice grown by virtually any method, including direct-seeded (broadcast seeding) paddy rice, upland rice farmed on dry land, or transplanted paddy rice where the seedlings are raised in a nursery plot prior to being transplanted. Application of this strain may be most effective for rice grown by the latter method, particularly when the paddy is constantly irrigated. When the roots of the rice plants are constantly wet, as they are in irrigated paddy fields, the microbial activity of Bacillus laterosporus strain CM-3 is optimized, and its protective effect, or its production of auxin-like compounds that stimulate plant growth, is concomitantly optimized. As noted above, the preferred dose rate for the present invention is from 0.6 trillion to 50 trillion cfu of Bacillus laterosporus strain CM-3 spores per hectare per crop cycle (i.e., the time required to produce one crop).

Bacillus laterosporus strain CM-3 can be applied to any type of grain, and to both conventional and hybrid rice varieties. During grow-out, applications of the spore suspension can be made manually, by backpack sprayer or by a more sophisticated mode such as by helicopter spraying. In the experiments described below, backpack spraying was the mode of application.

The spore suspension is preferably diluted with chlorine-free, fresh water prior to application. A typical blend might contain 4,500 ml of a fresh liquid spore suspension, testing with 400 million cfu/ml of CM-3 spores, which is then diluted in 225 liters of water and applied to one hectare of rice crop after transplanting. This one application delivers a dose of 1.8 trillion (1.8×10¹²) cfu/ha. It is also preferable if administration of such dose is repeated three times during the crop cycle, resulting in a total dose of 5.4 trillion cfu/ha. One application is made immediately after transplanting and then another at 20 days, then at 40 days following transplanting.

Depending on the variety, climate and age at transplanting, the rice grow-out cycle will run between 70 and 100 days following transplanting. Typically, in South Asia, a 30 day nursery period will be followed by about a 90 day grow-out period for a total crop cycle of 120 days. In parts of tropical Southeast Asia the total crop cycle averages 100-110 days.

More applications of the spores can be made and significantly higher doses can be applied (up to 50 trillion cfu/ha), if warranted by the conditions. Such conditions include attempting to produce hybrid seed which are under stress from copious pesticide use. However, the yield increases associated with application of the spores generally do not require doses in excess of about 6 trillion cfu/ha/crop cycle. One can also apply fresh vegetative cells having the characteristics of Bacillus laterosporus (preferably strain CM-3) as all or part of the dose applied to the crops. Normally this is not preferred because vegetative cells are not stable and lose viability rapidly after fermentation. To utilize vegetative cells of strain CM-3, the fermentation liquid should be used within 18-24 hours after beginning fermentation.

To maximize the benefits of spore application, the spores should first be applied during the plant's nursery stage, where the transplants are produced. Such a nursery inoculation program requires a relatively small number of spores on a per hectare after transplanting basis. It has been observed that the size and vigor of the transplants resulting from the nursery inoculation program is substantially greater compared to untreated, control transplants, and that the potential for higher yields is probably promoted. This may indicate that the potential for high yield may be compromised in rice plants that have not been inoculated and that various indigenous, possibly deleterious, root zone microorganisms may be responsible.

Examples of applying strain CM-3 to rice plants are set forth below.

### EXAMPLES

1. Exemplary Nursery Inoculation Program

Step one: Seed soaking. Ten kg of rice seed is soaked for two days in 10 liters of an aqueous suspension containing water and 2 to 10 million cfu/ml of strain CM-3 spores. A preferred concentration is 5-7 million spores/ml. Multiple soakings of 10 kg quantities of seed can take place simultaneously, or any other convenient amount of seed can be used as long as the above water dilution and spore dose is maintained.

Step two: Backpack spraying. After planting, the seeds are sprayed with 60-240 billion cfu of Bacillus laterosporus, strain CM-3, per 10 kg of seed. A preferred dose is 120 billion cfu per 10 kg of seed. Ten days after planting this spraying is repeated and another 60-240 billion cfu is applied to each area planted with 10 kg of seed; a preferred dose is 120 billion cfu. Typically, this dose is achieved by using about 300 ml of a spore suspension testing at 400 million cfu/ml, diluted in 15 liters of chlorine-free water.

Step three: Transplant root soaking. The transplants, after removal from the nursery soil (usually 28-30 days after planting), are bundled and soaked in a solution of CM-3 spores for at least 15 minutes but not exceeding 24 hours. The concentration of spores is between 2-10 million cfu/ml; a preferred concentration is 5-7 million cfu/ml. After soaking, the transplants are planted in the grow-out field.

Preferably, the total dose of spores contributed by the nursery inoculation program, assuming the nursery plot becomes part of the grow-out field, is about 300 billion to 1.2 trillion cfu/ha (3×10¹¹ to 1.2×10¹²) where about 25 kg of seed is used to produce the transplants for one hectare of grow-out capacity. At such dose, the contribution from all nursery inoculations is 600 billion or 0.6 trillion cfu/ha. The contribution from the spraying of the grow-out field, from three sprayings as described above, is 5.4 trillion cfu/ha. The sum total of spores applied is 6 trillion cfu/ha.

2. Improvements in Yield for Asian Rice

Bacillus laterosporus, strain CM-3, spores were prepared in tryptic soy broth shake flasks (200 ml in 4 liter baffled flasks) inoculated from a melted TSA slant culture, and incubated for 48 hours at 32° C. with a constant 100 rpm orbital agitation. This resulted in a spore suspension containing 400 million viable spores per ml. The spore suspension was diluted in water (150 ml in 10 liters of water) yielding 6 million spores/ml. Ten kg of rice seed, variety IR-64, was soaked in this 10 liters of diluted spore suspension for 2 days. The process was repeated to produce a total of 25 kg of innoculated seed, enough for a one hectare trial. The seed was planted in a nursery plot of about 1/10 hectare and sprayed immediately after planting with 120 billion cfu of CM-3 spores per 10 kg of seed (300 billion cfu for 25 kg of seed). Ten days after planting, this spraying was repeated. At 21 days the rice plants were removed, bundled and soaked for 18 hours in a suspension containing 6 million spores/ml. Following this treatment, the transplants were planted in a one hectare irrigated paddy field which included the nursery plot, and then immediately sprayed with 1.8 trillion cfu of CM-3 spores in 225 liters of water, using a backpack sprayer. This spraying was repeated at 20 and 40 days after transplanting, resulting in a dose of 5.4 trillion cfu/ha, plus a carry-over from the nursery inoculations of about 0.6 trillion cfu, to total about 6 trillion cfu/ha. The rice was fertilized with 240 kg of nitrogen from urea and grown with irrigation for 83 days under warm tropical conditions in Indonesia.

A one hectare control plot was managed exactly the same as described above for the test plants, except that no CM-3 spores were applied; only water was used during backpack spraying and soaking operations. After 104 days (21 days in a nursery and 83 grow-out days) the rice was harvested from both the test and control plots and various measurements were made on a random sample of 200 plants from each plot. The total weight of the grain harvested from each plot was recorded (in mt/ha). The common terms “shoot” and “ear” are used below, rather than the terms “tiller” and “panicle.”

Results
(Data averaged for 200 plants from each plot,
measurements made at 104 days)

| | CM-3 | | % |
|---|---|---|---|
| | treatment | Control | Improvement |
| Height of plant (cm) | 91 | 77 | 18 |
| Length of flag leaf (cm) | 35 | 33 | 6 |
| Number of active shoots | 27 | 15 | 88 |
| Number of grains per ear | 135 | 82 | 63 |
| Number of well filled grains/ear | 122 | 79 | 54 |
| Weight of 1,000 grains (g) | 28 | 32 | |
| Harvest in metric tons/ha | 7.3 | 4.7 | 55 |

3. Improvements in Yield for Latin American Rice

Bacillus laterosporus, strain CM-3, spores were prepared in tryptic soy broth shake flasks (200 ml in 4 liter baffled flasks) inoculated from a melted TSA slant culture, and incubated 48 hours at 32° C. with constant 100 rpm orbital agitation. This resulted in a spore suspension containing 400 million viable spores per ml. The spore suspension was diluted in water (30 ml in 2 liters of water) yielding 6 million spores/ml. Two kg of rice seed, variety INIAP 415, were soaked in the 2 liters of diluted spore suspension for 2 days. The process was repeated to produce a total of 12 kg of innoculated seed, enough for six trial plots of 100 square meters each—three CM-3 treated and three controls. The seed was planted in six nursery plots of about 10 sq. m. each, enough for the respective six trial plots. Immediately after planting, and again on the 8^{th} day thereafter, each nursery plot, except for the three controls, was sprayed using a backpack sprayer with 24 billion (24×10⁹) cfu of CM-3 spores. After completion of the nursery period (about 30 days) the plants were removed and soaked for 15 minutes in plastic trays containing 2 million cfu/ml of CM-3 spores, and were then planted in irrigated grow-out plots (separate from and not including nursery plot areas) and sprayed one time with 18 billion cfu of CM-3 spores (equivalent to 1.8 trillion/ha). After 110 days (30 days in the nursery and 80 days grow-out in the paddy) the rice was harvested from both the test and control plots and various measurements were made on random samples of 24 plants from each plot. The total weight of grain harvested from each plot was recorded. This study was conducted under warm tropical conditions in Ecuador.

Results
(Data averaged for 24 plants from each replicate plot-
measurements made at 110 days)

| | CM-3 | | % |
|---|---|---|---|
| | treatment | Control | Improvement |
| Height of plant (cm) | 122 | 123 | |
| Foliage weight/plant (g) | 62 | 48 | 29 |
| Wet root weight/plant (g) | 47 | 29 | 62 |
| Number of shoots/plant | 25 | 19 | 32 |
| Number of ears/plant | 24 | 18 | 33 |
| Number of full grains/plant | 110 | 89 | 24 |
| % Blank grains/plant | 12 | 14 | |
| Weight of 100 grains | 29.2 | 28.6 | 2.0 |
| Yield/plant (g) | 52 | 40 | 30 |
| Yield/100 sq.m.plot (kg) | 66 | 49 | 35 |
| Yield/hectare (mt) | 6.56 | 4.88 | 34.4 |

4. Improvements in Yield from High Dose Treatment Using Broadcast Seeding

A spore suspension of Bacillus laterosporus, strain CM-3, was prepared in a 2000 liter fermentor of Schaeffer's Sporulation Medium. The medium was sterilized at 121° C. for 30 minutes, cooled to 32° C. and inoculated at 1% by volume with a shake flask culture of Bacillus laterosporus, strain CM-3. The initial pH was adjusted to 6.8 with either HCl or NaOH and the fermentor was agitated at 150 rpm while sterile air was sparged into the liquid culture at a rate of 500 liters of air/minute. Temperature was controlled at 32° C. for 45 hours. This resulted in a spore suspension containing 400 million viable spores/ml. A total of 50 trillion cfu/ha (50×10¹² cfu/ha) was applied to rice (variety IR-64) that had been broadcast seeded (no nursery step) directly onto one hectare of irrigated peat soil on the island of Java in Indonesia. Fertilizer was applied at the rate of 120 kg/ha of N from urea prior to planting. The application of CM-3 spores was in two divided doses, each diluted in 225 liters of chlorine-free, fresh water. The first application immediately followed planting and the second followed emergence, and both were by helicopter spraying. Yield results were reported in mt/ha 110 days after sowing the seeds.

Results

| Treatment | Yield (mt/ha) |
|---|---|
| None (control) | 2.2 |
| CM-3 (50 trillion cfu) | 4.3 |
| % Improvement | 95% |

5. Improvements in Yield from Low Dose Applications to Rice in a Grow-Out Field

Bacillus laterosporus strain CM-3 spores were prepared in tryptic soy broth shake flasks (200 ml in 4 liter baffled flasks) inoculated from a melted TSA slant culture, and incubated for 48 hours at 32° C. with constant 100 rpm orbital agitation. This resulted in a spore suspension containing 200 million viable spores per ml. The spore suspension was then diluted in water (300 ml in 10 liters of water) yielding 6 million spores/ml. Ten kg of rice seed, variety IR-64, was soaked in this 10 liters of diluted spore suspension for 2 days. The process was repeated to result in a total of 25 kg of seed, enough for a one hectare trial. The seed was planted in a nursery plot of about 1/10 hectare and sprayed immediately after planting with 120 billion cfu of CM-3 spores per 10 kg of seed (300 billion cfu for 25 kg of seed). Ten days after planting the above spraying was repeated. 25 days after planting the rice plants were removed, bundled and soaked for 18 hours in a suspension containing 6 million spores/ml. Following this treatment the transplants were planted in an irrigated one hectare grow-out paddy field in tropical Indonesia. There were no additional applications of CM-3 spores to the grow-out field, and it is estimated that about 0.6 trillion cfu were contributed by the nursery plot treatments, which became incorporated onto the plants in the grow-out field. The rice was fertilized with 240 kg of nitrogen from urea and grown with irrigation for 85 days under warm tropical conditions in Indonesia. A one hectare control plot was managed exactly as for the test plot except that no CM-3 spores were applied; only water was used in backpack spraying and soaking operations. After 110 days (25 days in the nursery and 85 grow-out days) the rice was harvested from both the test and control plots and the yields were reported in mt/ha along with the percent “solid rice” for each, since blank grains were not separated prior to harvest.

Results

| | | % | |
|---|---|---|---|
| Treatment | Yield (mt/ha) | Improvement | % Solid Rice* |
| None (control) | 5.5 | | 65 |
| CM-3 (50 trillion cfu) | 7.0 | 27% | 70 |

*Blank grain was not separated prior to harvest

The invention includes numerous variations, modifications and alterations of the embodiments and methods described in the specification above, and the scope of the invention is not defined or limited by this specification or by the examples, but is defined only in the claims that follow, and includes all equivalents of the subject matter of the claims.

What is claimed is:

1. A process for increasing grain crop yield comprising applying Bacillus laterosporus strain CM-3 (deposited at the American Type Culture Collection, P.O. Box 1549, Manassas Va. 20108, under accession No. PTA-3593) spores or live cells to growing grain plants.

2. The process of claim 1 wherein the spores or live cells are applied to growing rice plants.

3. The process of claim 1 wherein the spores or live cells are applied in multiple applications beginning while the plants are in a nursery.

4. The process of claim 2 wherein the spores or live cells are applied to direct-seeded rice plants.

5. The process of claim 1 wherein the spores or live cells are applied in combination with spores or cells of a gram-negative Pseudomonas bacterial species.

6. The process of claim 2 comprising applying from 0.6 to 50 trillion (0.6 to 50×10¹²) colony forming units of spores of Bacillus laterosporus strain CM-3, in a water suspension, per hectare of rice crop.

7. The process of claim 3 wherein spores are applied to rice plants during the nursery period at an effective dosage of from 60-240 billion colony forming units per 10 kg of rice seed.

8. The process of claim 7 wherein, following the nursery period, the roots of rice plants are immersed in a water suspension of spores and the concentration of the spores is between 2-10 million colony forming units/ml.

9. The process of claim 8 wherein the water in the suspension is chlorine-free and the suspension includes one or more of the following: nutrient organic compounds, trace minerals, vitamins, growth factors and adjuvants.

10. A composition comprising substantially purified spores or live cells of strain CM-3 of Bacillus laterosporus (deposited at the American Type Culture Collection, P.O. Box 1549, Manassas Va. 20108, under accession No. PTA-3593).

11. The composition of claim 10 in a water suspension, wherein the water is substantially chlorine-free.

12. The composition of claim 11 further including one or more of nutrient organic compounds, trace minerals, vitamins, growth factors and adjuvants.
